(19) United States
(12) Patent Application Publication
(10) Pub. No.: US 2006/0012739 A1
(43) Pub. Date: Jan. 19, 2006

(54) Optical substrate, display device using the same, and their manufacturing methods

(75) Inventor: Minoru Shibazaki, Kobe-Shi (JP)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Eletcronics N.V., Eindhoven (NL)

(21) Appl. No.: 10/539,252

(22) PCT Filed: Dec. 1, 2003
(86) PCT No.: PCT/IB03/05672

§ 371 Date: Jun. 15, 2005

(30) Foreign Application Priority Data
Dec. 20, 2002 (JP) 2002370825

(51) Int. Cl. G02F 1/1333

(52) U.S. Cl. 349/122

(57) ABSTRACT

An object of the invention is to provide an optical collective substrate and a display device using it, which can make effective use of light while avoiding generation of chromatic aberration in transmitted light. An optical substrate (20) of an optically transmissive material having a structure in which incident light Li from one principal plane (21) side of the substrate is locally focused toward an array of apertures (201) formed on the other principla plane (22). The one principal plane (21) is provided with grooves 2v being filled with an optically transmissive substance 2m of a predetermined refractive index, the filled groove portions 2V allowing the incident light Li from the one principal plane (21) side to be collected onto the respective apertures (201).

### BACKGROUND OF THE INVENTION

1. Field of the Invention

The present invention relates to an optical collective substrate used in a liquid crystal display device etc., and its manufacturing method. The invention also relates to a display device using the optical collective substrate and its manufacturing method.

2. Description of Related Art

A liquid crystal panel is disclosed that has a structure where a group of lenses is disposed between the backlight and display electrodes, and collects light from the backlight in the respective display electrodes on a pixel basis (for example, see Patent Reference 1).

[Patent Reference 1]

Japanese Patent Application Laid-Open No. 89025/90 (pages 2 to 3 and FIGS. 1 to 3)

In a liquid crystal panel described in this Reference, as a group of lenses mentioned above, a lens array plate is used where a large number of lenses based on high-refractive-index portions, convex sphere, etc. are formed in matrix on a transparent plate different from a liquid crystal panel substrate using, or the liquid crystal panel substrate itself has a lens array with the similar structure. By means of the lens array, light of the backlight that has been intercepted in an untransmissive portion around the display electrode is mostly collected to the display electrode, the light is intended to be used effectively, and the luminance of pixels is enhanced without increasing the driving power of the backlight.

However, in the prior art, a planoconvex lens with a spherical convex surface is used as a lens that collects light to the display electrode, i.e., pixel electrode. Therefore, chromatic aberration or the like is apt to occur in the transmitted light, which is not preferable, and particularly, may become a considerable problem for display devices that display color images.

In addition there is a tendency to place an excessive load on the manufacturing process for forming the convexity of the lens in an appropriate spherical surface. In particular, as miniaturization of the pixel is advanced due to a demand for high resolution of image, the size of a lens has to be reduced more and more, and so the prior art has disadvantages.

Furthermore, the liquid crystal display device or the like generally uses various optical elements or other structural elements in addition to the member or structure for the lens, and so the actual situation is that the so-called workability has to be taken into account in a combination of the lens member and the structural elements.

### SUMMARY OF THE INVENTION

In view of the foregoing, an object of the present invention is to provide an optical collective substrate and a display device using it, which can make effective use of light while avoiding generation of chromatic aberration etc. in transmitted light.

Another object of the present invention is to provide an optical collective substrate and a display device using it, which can make effective use of light and can be simply manufactured.

Still another object of the present invention is to provide an optical collective substrate and a display device using it, which achieves high workability in a combination with other structural elements.

A further object of the present invention is to provide methods of manufacturing such optical collective substrates and display devices.

In order to achieve the above objects, an optical collective substrate according to an aspect of the present invention is an optical collective substrate of an optically transmissive material having a structure in which incident light from one principal plane side of the substrate is locally collected in each place toward an array of light-utilizable areas formed on the outside of the other principal plane, wherein the one principal plane is provided with a groove comprising an outline having at least one inclined plane associated with the light-utilizable area, the groove being filled with optically transmissive stuff of a predetermined refractive index, the filled groove portions making bases for allowing the incident light from the one principal plane side to be collected to the respective light-utilizable areas.

According to this aspect, the incident light is collected to the respective light-utilizable areas using the groove portions filled with the optically transmissive stuff, instead of using the spherical lens, whereby chromatic aberration etc. caused by the spherical lens hardly occur in the collected light, and it is possible to use appropriate light with ease and with high efficiency for color display. Further, since it is only required to form the groove on one principal plane of the optical collective substrate, this structure does not need conventional complicated processes for forming a spherical lens and thus is simple. In particular, this structure is advantageous to display devices that handle fine pixels. Furthermore, since the groove is formed on the side (one principal plane of the optical collective substrate) on which the light is incident, and is not formed on the side (the other principal plane) on which the light-utilizable areas are arranged, the other principal plane can be used with the plane kept flat or unprocessed when the optical collective substrate is used, for example, as a back substrate of a typical liquid crystal display device, resulting in an advantage of making it easy to form on the other principal plane other structural elements, such as thin-film transistors (TFTs) for driving pixels, required for the display device. In addition to this advantage, the optically transmissive stuff used for filling the grooves is readily formed to have a height equal to a height of the portions other than the groove in the one principal plane, whereby it is thus possible to maintain a high degree of flatness even in the one principal plane of the optical collective substrate, and it is easy to paste other structural elements, for instance, polarizing plate to the plane or the like. This structure thus exhibits high workability.

In this aspect, the groove may extend along at least a part of an edge of the light-utilizable area. It is thereby possible to form the groove with a simple pattern.

Moreover, it is preferable that the one principal plane has planes extending with a substantially equal height in areas other than the groove. In this way, since the planes have the height equal to one another, it is also possible to achieve effective pasting of other structural elements as described above in the one principal plane of the optical collective substrate.

Further in this aspect, the optically transmissive stuff may have a function of pasting an additional film to the one principal plane. In this way, the optically transmissive stuff also servers as an adhesive in forming the additional film, i.e., another structural element on the one principal plane of the optical collective substrate, thereby providing extreme convenience in manufacturing.

In order to achieve the above objects, a display device according to another aspect of the present invention is a display device using an optical collective substrate described above, comprising a display medium for forming images, which is disposed on the other principal plane side and carried on the optical collective substrate, the display device having pixels or predetermined displayed units corresponding to the light-utilizable areas.

According to this aspect, since light is collected to pixels or predetermined displayed units of the medium for forming images in the display device, it is possible to make each of the pixels or predetermined displayed units bright and to display clear images on the whole. Further, this aspect preferably leads to mitigation of the above-mentioned problem about chromatic aberration etc. Furthermore, since the other principal plane side of the optical collective substrate is flat or unprocessed, it is easy to form other structural elements required for the display device, thus providing convenience. When an additional film is pasted to the one principal plane by the optically transmissive stuff, since it is possible to eliminate an adhesive that has been conventionally prepared separately for pasting an additional film such as an optical film to the substrate, the processes are simplified. The structure of the display device is applicable to a liquid crystal display device using a liquid crystal medium as a medium for forming displayed images, and is remarkably effective in covering a loss of light that is inevitable due to a polarizing plate or the like used in a general liquid crystal display device.

In order to achieve the above objects, a method of manufacturing an optical collective substrate according to still another aspect of the present invention is a method of manufacturing an optical collective substrate of an optically transmissive material having a structure in which incident light from one principal plane side of the substrate is locally collected in each place toward an array of light-utilizable areas formed on the outside of the other principal plane, comprising: a first step of forming, in the one principal plane, a groove comprising an outline having at least one inclined plane associated with the light-utilizable area; and a second step of filling the groove with optically transmissive stuff of a predetermined refractive index, and in addition to this, the optically transmissive stuff may have an adhesive property and the method may further comprise a third step of affixing an additional film on the one principal plane using the adhesive property of the optically transmissive stuff, or in addition to this, the second step may include a process of applying the optically transmissive stuff to the one principal plane of the optical collective substrate globally.

According to this aspect, it is possible to easily manufacture the optical collective substrate having the advantages described above. When the grooves are formed using a pattern along at least a part of the edges of the light-utilizable area, loads on manufacturing are greatly reduced, as compared with the conventional forming of the spherical lens. Furthermore, the first step may comprise a masking process of covering the one principal plane with a mask having a pattern that causes an area of a groove to be formed to be exposed and causes the other area to be masked and a spraying process of spraying the masked one principal plane of the optical collective substrate with a substance capable of etching the material of the optical collective substrate, and in the spraying process a spraying nozzle may be used to blast the substance capable of etching, positioned opposed to the area of the groove externally appearing from the mask, and moved along the extending pattern of the area of the groove while spraying the substance capable of etching in a condition that the nozzle is positioned at a center of the area of the groove in a direction traversing a moving direction of the nozzle, whereby the groove is formed with excellence.

In order to achieve the above objects, a method of manufacturing a display device according to still another aspect of the present invention is a method of manufacturing a display device using an optical collective substrate of an optically transmissive material having a structure in which incident light from one principal plane side of the substrate is locally collected in each place toward an array of light-utilizable areas formed on the outside of the other principal plane, wherein: the one principal plane is provided with a groove comprising an outline having at least one inclined plane associated with the light-utilizable area, the groove being filled with optically transmissive stuff of a predetermined refractive index, the filled groove portions making bases for allowing the incident light from the one principal plane side to be collected to the respective light-utilizable areas, the method of manufacturing comprising: a step of forming such a display mechanism construction including a display medium for forming an image on the other principal plane side of the optical collective substrate that the construction has pixels or predetermined displayed units corresponding to the light-utilizable areas, and furthermore, the method may further comprises a step of pasting an additional film to the one principal plane of the optical collective substrate, wherein an adhesion property of the optically transmissive stuff makes adhesion of the additional film. It is thereby possible to manufacture display devices capable of satisfactorily exhibiting the advantages described above.

### BRIEF DESCRIPTION OF THE DRAWINGS

FIG. 1 is a schematic plan view of a part of an optical collective substrate of one embodiment according to the present invention.

FIG. 2 is a schematic sectional view of a part of an optical collective substrate, taken along a line II-II of FIG. 1.

FIG. 3 is a perspective view of a part of the optical collective substrate of FIGS. 1 and 2.

FIG. 4 is a sectional view showing a general construction of a part of a transmissive liquid crystal display device using the optical collective substrate of FIGS. 1-3.

FIG. 5 is a schematic plan view showing a combinational form of a TFT-composite layer and a black matrix in a liquid crystal display device of FIG. 4.

FIG. 6 is a schematic sectional view showing an actual form of adhesion of a film to an optical collective substrate in the invention.

FIG. 7 is a partial sectional view showing a general construction of a reflective liquid crystal display device using an optical collective substrate according to the invention.

FIG. 8 is a partial sectional view showing a general construction of a transflective liquid crystal display device using an optical collective substrate according to the invention.

FIG. 9 is a schematic plan view showing a construction of a pixel electrode used in a liquid crystal display device of FIG. 8.

FIG. 10 is a schematic sectional view of a part of an optical collective substrate of the other embodiment according to the invention.

FIG. 11 is a schematic sectional view of a part of an optical collective substrate of a further embodiment according to the invention.

### DESCRIPTION OF THE PREFERRED EMBODIMENT(S)

The aforementioned aspects and other embodiments of the present invention will now be described in more detail with reference to accompanying drawings.

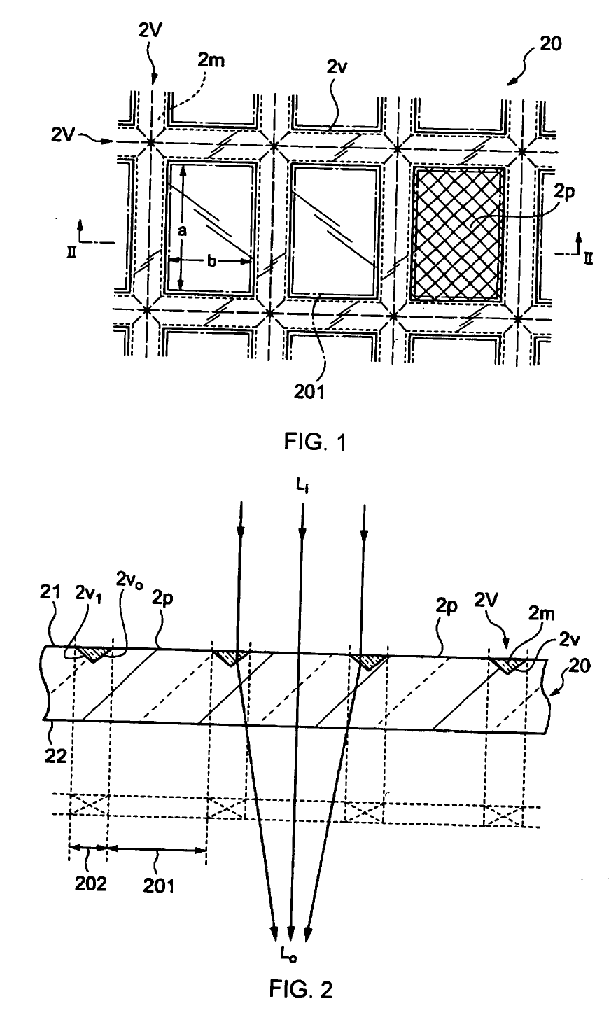

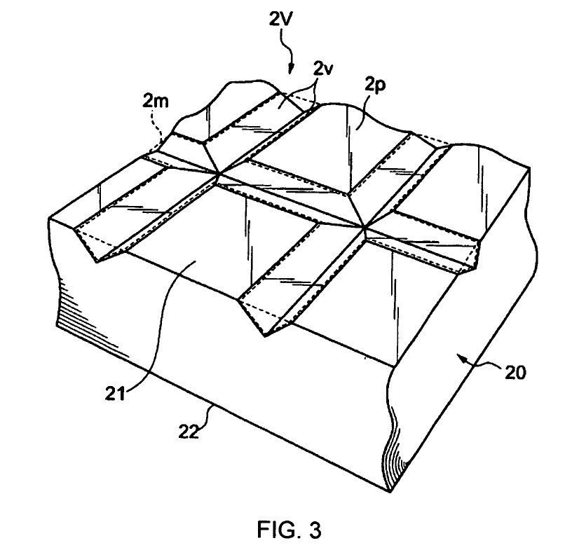

FIG. 1 shows a view in which one principal plane of an optical collective substrate according to one embodiment of the present invention is taken from its front side. FIG. 2 shows a sectional structure of the optical collective substrate, taken along a line II-II of FIG. 1. FIG. 3 is a view in which a part of the optical collective substrate is taken obliquely.

An optical collective substrate 20 consists of an optically transmissive material such as glass and formed in the shape of a flat plate with one principal plane 21 having an area covering a predetermined display area and the other principal plane 22 on the opposite side to the plane 21. As in the conventional technique, the optical collective substrate 20 has a function of collecting incident light Li from the one principal plane 21 side locally in each place toward an array of light-utilizable areas 201 (described later) formed on the outside of the other principal plane 22. However, in the optical collective substrate 20 in this embodiment, instead of a spherical structure, V-shaped grooves 2v are formed on the one principal plane 21 in association with the light-utilizable areas 201. More specifically, each of the grooves 2v is comprised of an inclined surface 2v₀ slanted to one of the light-utilizable areas 201 and an inclined surface 2v₁ slanted to another (adjacent) light-utilizable area 201. The V-shaped groove 2v is filled with optically transmissive stuff 2m of a predetermined refractive index different from that of the substrate body (which is preferably smaller than that of the substrate body), and the filled groove portions 2V make bases for allowing the incident light Li from the one principal plane 21 side to be collected to the respective light-utilizable areas 201 as transmitted light Lo shown in FIG. 2.

The array of the light-utilizable areas 201 herein refers to areas requiring light collection in a display device disposed on the other principal plane 22 side to be applied. A specific example will be described later. The V-shaped groove 2v is formed in association with the light-utilizable areas 201 so that the V-shaped groove portions 2V collect the light to the light-utilizable area 201, and on the other hand, can be practically formed in locations opposite to areas 202 that do not utilize light. In the plan view of FIG. 1, light-utilizable areas 201 are indicated schematically by alternate long and short dashed lines in superposition.

The V-shaped groove 2v extends along at least a part of an edge of the light-utilizable area 201, in this example, in form of surrounding the area 201. Accordingly, it is possible to pattern the V-shaped groove 2v with ease without complicated optical consideration. The V-shaped groove 2v has a pair of inclined surfaces that form the V-shaped outline in the sectional view, and the one principal plane 21 of the optical collective substrate 20 has a plurality of flat surfaces 2p (corresponding to a cross-hatching area in FIG. 1, and other flat surfaces are the same) extending with a substantially equal height in areas other than the inclined surfaces, i.e., other than the V-shaped groove portions 2V.

Optically transmissive stuff 2m as a filler may be a material having an adhesion property such as viscous or adhesive materials, e.g. a mixture of acrylic ester copolymer and polyurethane resin. According to the adhesion property, it is convenience to bring an additional film such as other optical films into intimate contact with the one principal plane 21 of the optical collective substrate 20. A photosetting resin may also be used as a material for the optically transmissive stuff 2m.

In thus structured optical collective substrate 20, instead of using spherical lenses, using the V-shaped groove portions 2V each of which is filled with optically transmissive stuff 2m and has flat inclined surfaces as interfaces for refraction of light, the incident light is collected toward each of the light-utilizable areas 201. Therefore, the collected light Lₒis hardly subjected to chromatic aberration or the like that may be generated when a spherical surface of the spherical lens is used as an interface of light refraction, and it is possible to use appropriate light with ease and with high efficiency for color display. Furthermore, since it is only required to form the V-shaped groove 2v comprised of two flat inclined surfaces on the one principal plane 21 of the optical collective substrate 20, it results in advantageous aspect of processing with a high degree of precision and results in simplified processes. This feature is advantageous especially for display devices that handle fine pixels.

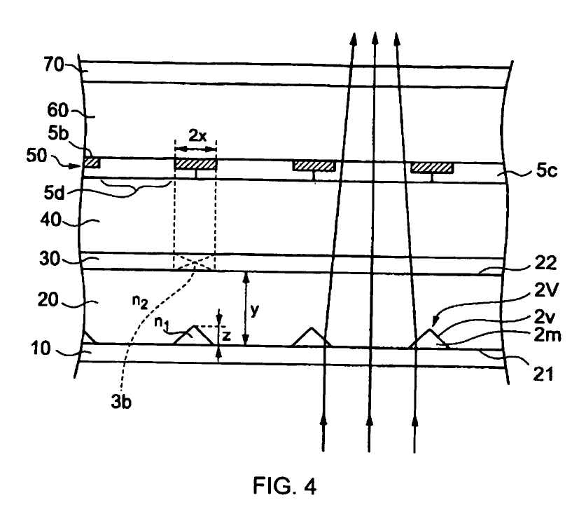

FIG. 4 shows an example of a transmissive type liquid crystal display device constructed using the optical collective substrate 20.

In FIG. 4, the optical collective substrate 20 is used as a back substrate that carries a liquid crystal medium 40 together with a front substrate 60. The one principal plane 21 of the optical collective substrate 20 is situated on the outside of the display device, while the other principal plane 22 is situated on the inside of the display device.

The optical collective substrate 20 is provided on its outside with a polarizing plate 10, while being provided on its inside with a TFT-composite layer 30. The front substrate 60 is provided on its outside with another polarizing plate 70, while being provided on its inside with a color filter 50.

It is noted that various other films and layers specific to a liquid crystal display device may be formed in addition to those described above, but will be omitted as long as a note is not given for the sake of clarity of description.

As shown in FIG. 4, the color filter 50 is provided with a black matrix 5b for masking an area in which a pixel is not formed against the display surface side. A non-shield areas 5d where a layer of the black matrix 5b are not formed is occupied by a coloring layer 5c, and the optical collective substrate 20 is applied and incorporated using the non-shield areas 5d as the light-utilizable areas 201 described above.

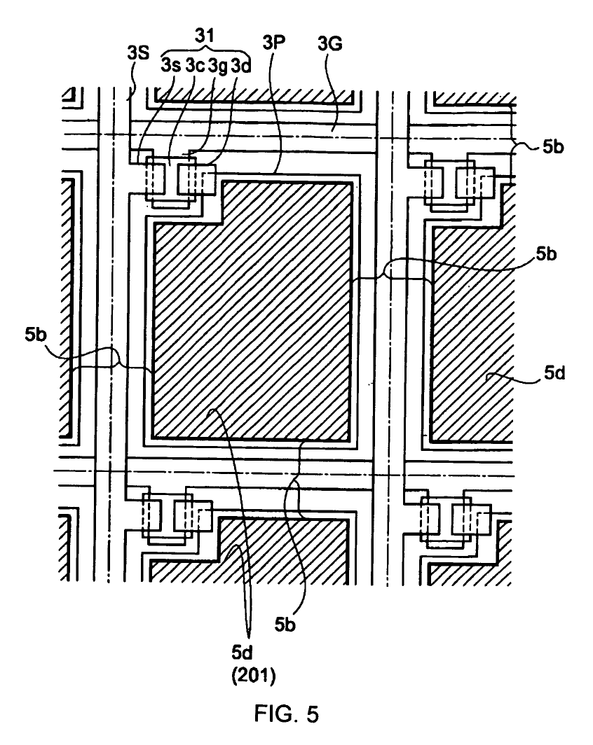

The non-shield area 5d of the black matrix 5b will be described specifically below with reference to FIG. 5.

FIG. 5 shows a plan view in which the black matrix 5b for a pixel, and the thin-film transistor (TFT) 31 and a pixel electrode 3P for a pixel in the TFT-composite layer 30 are overlaid on each other.

The TFT 31 basically has a gate electrode 3g drawn from a gate bus line 3G, a semiconductor layer 3c deposited on the electrode 3g via a gate insulating film not shown, a drain electrode 3d in contact with the semiconductor layer 3c from one side of the layer 3c, and a source electrode 3s that is in contact with the layer 3c from the other side of the layer 3c and is drawn from a source bus line 3S. The drain electrode 3d extends in the direction opposite to the source electrode 3s, and connects to the pixel electrode 3P consisting of a transparent conductive material such as ITO (Indium Tin Oxide). With the TFT 31, voltage corresponding to pixel information is supplied to the pixel electrode 3P via the drain electrode 3d, and the pixel electrode 3P applies the voltage locally in that area to a portion of the liquid crystal medium 40 facing to the electrode 3P.

As indicated by bold lines in FIG. 5, the black matrix 5b is formed to mask the bus lines 3S and 3G, the entire TFT 31 and an outer edge of the pixel electrode 3P. Accordingly, setting the area (non-shield area) 5d indicated by oblique lines in FIG. 5 as the light-utilizable area 201 achieves the advantages specific to the optical collective substrate 20 as described above. It is noted that, as can be seen from FIG. 5, the non-shield area 5d is not a perfect rectangle because the TFT 31 exists. However, with the area 5d assumed to approximately have a rectangle-shaped form, a pattern of the V-shaped groove portion 2V cab be specified. The alternate long and short dashed lines in FIG. 5 indicate a position of a center or back end portion, i.e., a bottom portion of the V-shaped groove 2v of the optical collective substrate 20. In this embodiment, the bottom position is located in a center in the traversing direction of a pattern of the black matrix 5b.

In this embodiment, the light-utilizable area 201 is set to the non-shield area 5d of the black mask layer, but may be an area of the pixel electrode 3P formed in the TFT-composite layer 30. In addition, in a top-gate type TFT structure, instead of the so-called bottom-gate type TFT structure, a light shield film is generally provided in an underlayer portion of the TFT-composite layer so that light from the backlight does not enter a semiconductor layer of the TFT, and an area that is not shielded by the shield film can be used as a light-utilizable area 201. In any cases, a liquid crystal display device is constructed so that a pixel structure is formed in relation to (association with) the light-utilizable area 201. It is noted that the embodiment takes a form in which one light-utilizable area corresponds to one pixel area (implying an area substantially considered to be a pixel area), but one light-utilizable area may be a predetermined displayed unit, i.e., two or more pixel areas, or sub-areas that are divisional portions of one pixel area.

The V-shaped groove 2v is formed on the side 21 on which light is incident, and is not formed on the side 22 on which the light-utilizable areas 201 are arranged. Therefore, in the liquid crystal display device using the optical collective substrate 20 as a back substrate, the other principal plane 22 can be used with the plane 22 kept flat or unprocessed. Accordingly, there is an advantage that the principal plane 22 is easy to form structural elements such as TFTs 31 and pixel electrodes 3P thereon.

As shown in FIG. 2, it is also easy to make the height of optically transmissive stuff 2m with which the V-shaped groove 2v is filled equal to the height in portions other than the V-shaped grooves 2v of the principal plane 21 to form a flat surface as a whole. The flat principal plane 21 enhances the adhesion of other structural elements such as the polarizing plate 10 to the plane 21. Further, the principal plane 21 of the optical collective substrate 20 has flat planes 2p with the same height except the V-shaped groove portions 2V, and thus is advantageous for tighter pasting. As an additional remark, since the V-shaped groove 2v is filled with optically transmissive stuff 2m that is not air, a film affixed to the principal plane 21 is hard to remove.

Thus, in the liquid crystal display device, the light from the backlight departs from originally light-shielded areas and is collected toward pixels or predetermined displayed units as light-utilizable areas. Accordingly, it is possible to make each of the pixels or redetermined displayed units bright and to display clear images on the entire display screen. Furthermore, the problem of the chromatic aberration or the like as mentioned above can be mitigated to implement excellent color display.

Moreover, the optically transmissive stuff 2m with the adhesion property is convenient for pasting the polarizing plate 10 to the substrate.

Herein, as a simple estimation, a comparison will be described below between a case of using an ordinary transparent substrate without the light-collecting function as a back substrate in a liquid crystal display device and a case of using the optically collective substrate 20 of this embodiment as the same.

When the liquid crystal layer 40 is fixed to a predetermined optical modulation state and it is assumed that the transmittance of the polarizing plates 10 and 70 is Tp, the transmittance of the color filter 50 is Tc, and an aperture ratio (a ratio of the effective area of all the non-shield areas to the effective area of all the display areas) is AR, transmittance T of the apparatus in the former case is approximately calculated as follows.
T≈Tp×Tc×AR≈50%×33%×0.6 ≈10%

On the contrary, when considered AR=1.0 due to the light-collecting function of the optical collective substrate 20, transmittance T of the apparatus in the latter case under the same conditions is approximately calculated as follows.
T≈Tp×Tc×AR≈50%×33%×1.0≈17%

Accordingly, the latter case, i.e., this embodiment increases the luminance approximately 1.7 times as much.

In this way, even when a loss of light is occurred in the polarizing plates 10 and 70, it is possible to increase the luminance in the entire display device. Since the polarizing plates are required be used in most of liquid crystal display devices, this structure is significantly useful.

It is preferable to set the groove portions 2V of the optical collective substrate 20 for optimal specifications as appropriate in accordance with an applied display device. For example, when it is assumed that vertical and horizontal sizes of the light-utilizable area are respectively a and b (see FIG. 1), the refractive index of the optically transmissive stuff 2m is n₁, the refractive index of the main body of the optical collective substrate 20 is n₂, the width of the shield area 5b is 2x, the distance from the groove portion 2V to the substrate 20 is y, and the height of the groove 2v is z (see FIG. 4), an excellent result was obtained under conditions that a=300 μm, b=100 μm, n₁=1.3, n₂=1.5, 2x=20 μm, y=400 μm, and z=2 μm. It is noted that air can be used as a substitute for the optically transmissive stuff 2m , but excellent light-collecting function was not obtained in the case of the air. This is because in a structure where a V-shaped groove portion is disposed on the outside of the liquid crystal panel, the V-shaped groove portion consisting of the air tends to cause the light to spread excessively. As a further note, the reason for assuming the distance from the groove portion 2V to the substrate 20 as y is: considering that a structural portion 3b (see FIG. 4) such as a bus line and/or light shield film in which the light is not used practically exists under the shield member 5b; and that the light is collected getting away from the structural portion. Since the layers 30, 40 and 50 are generally formed to have an extremely thinner thickness than that of the substrate 20, there is also a case of designing an optimal structure by assuming the distance from the groove portion 2V to the shield member 5b as y even when such a structural portion exists.

The optical collective substrate 20 is manufactured as described below.

Basically carried out are:

(1) a first step of forming the V-shaped groove 2v on the one principal plane 21 in association with the light-utilizable areas 201; and

(2) a second step of filling the V-shaped groove 2v with the optically transmissive stuff 2m of a predetermined refractive index.

In the first step, a masking process is carried out, in which the one principal plane 21 is covered with a matrix-formed mask having a pattern that causes an area of the V-shaped groove 2v to be formed to be exposed and causes the other area to be masked. Then, a spraying process is carried out, in which the masked one principal plane 21 of the optical collective substrate 20 is sprayed with a substance capable of etching the material of the optical collective substrate 20. In this example, the material of the optical collective substrate 20 is glass (SiO₂), and as the substance capable of etching for the glass, i.e., etchant, a hydrofluoric acid solution is blasted in mist state.

More specifically, in the spaying process, a spraying nozzle is used to blast the hydrofluoric acid solution. The spraying nozzle has a practical outlet face opposite to an area for the V-shaped groove unmasked in the matrix-formed mask, and is moved along the extending pattern for the area for the V-shaped groove. At the occasion of this preferably the solution blasted from the nozzle is sprayed in the form of a beam and the etchant is sprayed with the nozzle positioned at a center of the width of the V-shaped groove 2v in a direction traversing a moving direction of the nozzle. In this way, it is possible to position a bottom of the groove at the center of the width of the groove pattern with precision and to form a V-shaped cross-section appropriately.

When the optically transmissive stuff 2m is paste stuff such as, for example, a mixture of acrylic acid ester copolymer and polyurethane, the polarizing plate 10 can be pasted to the one principal plane 21 using the adhesion property of the optically transmissive stuff 2m in a third step. It should be noted that, instead of the polarizing plate, it may be possible to paste other various films and layers such as a protect film and a quarter-wave plate as needed in the applied system.

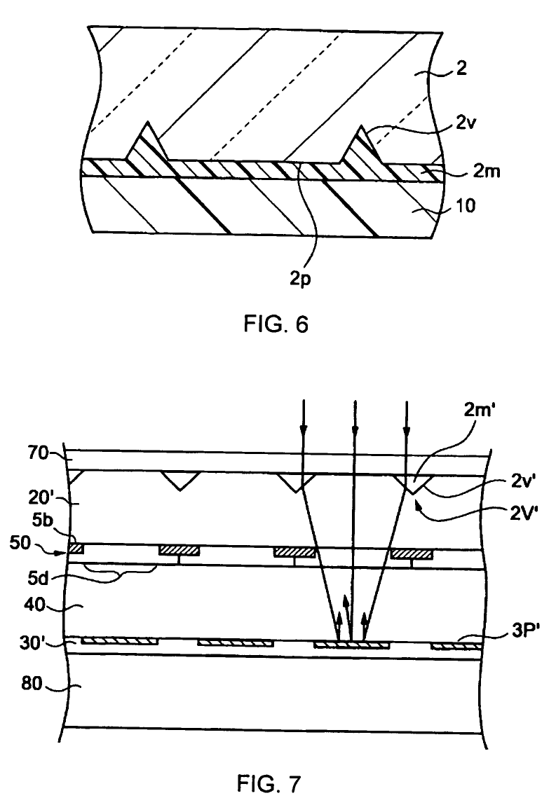

Further, in the second step, the filling step can be carried out by coating the whole surface of the one principal plane 21 of the optical collective substrate 20 with the optically transmissive stuff 2m in spin coating. Accordingly, as shown in FIG. 6, the optically transmissive stuff 2m is practically disposed on the flat plane 2p, not only inside the V-shaped groove 2v but also.

Instead of using the paste stuff described above, a photosetting resin may be used as optically transmissive stuff 2m. In this case, the resin in paste state is first applied to the V-shaped groove and the principal plane, the additional film is placed thereon, and then the light is applied from the opposite principal plane, whereby the resin is cured, the groove portion 2V is formed, and the additional film adheres thereto.

In order to manufacture a liquid crystal display device using the optical collective substrate, there may be basically carried out a step of forming a construction including a display medium for forming an image on the other principal plane 22 side of the optical collective substrate 20 in such a manner that the construction has pixels or predetermined displayed units corresponding to the light-utilizable areas 201 (in the above embodiment, non-shield areas 5d in the layer of black matrix 5b) defined on the optical collective substrate 20. The third step may be carried out at this occasion.

Although the specific example of the first step mentioned above depends on the so-called etching processing, the V-shaped groove 2v may be formed by scribing with a scriber, or may carry out a grinding process of grinding the principal plane with a grinder to form the groove.

FIG. 7 shows an example of a reflective liquid crystal display device constructed using the optical collective substrate, and portions similar to those in FIG. 4 are assigned the same reference numerals as in FIG. 4.

In FIG. 7, an optical collective substrate 20′ is used as a front substrate, and one principal plane of the substrate is faced to the display surface side. A back substrate 80 is a typical substrate prepared for principally carrying a TFT composite layer 30′ or other layers. In the TFT composite layer 30′, a pixel electrode 3P′ having a light reflective property is formed, and the pixel electrode 3P′ has a function of reflecting the light incident from the front side as well as a function of locally applying the voltage to the liquid crystal layer 40.

The optical collective substrate 20′ is also formed using the non-shield area 5d in the layer of black matrix 5b as the light-utilizable area 201, but has a shorter distance from a V-shaped groove portion 2V′ to the light-utilizable area than that in the case of FIG. 4, and thus has different conditions to collect the light from those in the case of FIG. 4. Accordingly, the optical collective substrate 20′ is formed to adapt to such different conditions. In other words, the inclination of the inclined surfaces of the V-shaped groove 2v′, the refractive index of the optically transmissive stuff 2m′ and so on are optimized in accordance with the conditions. Since the degree of narrowing the light is higher than that in the case of FIG. 4, the optimization is carried out basically by making the inclined surfaces of the V-shaped groove 2v′ steeper, and/or by decreasing the refractive index of the optical collective stuff 2m′.

It is noted that other structural elements are also modified in property and structure to be adapted to the reflective liquid crystal display device, but descriptions thereof are omitted herein for the sake of clarity.

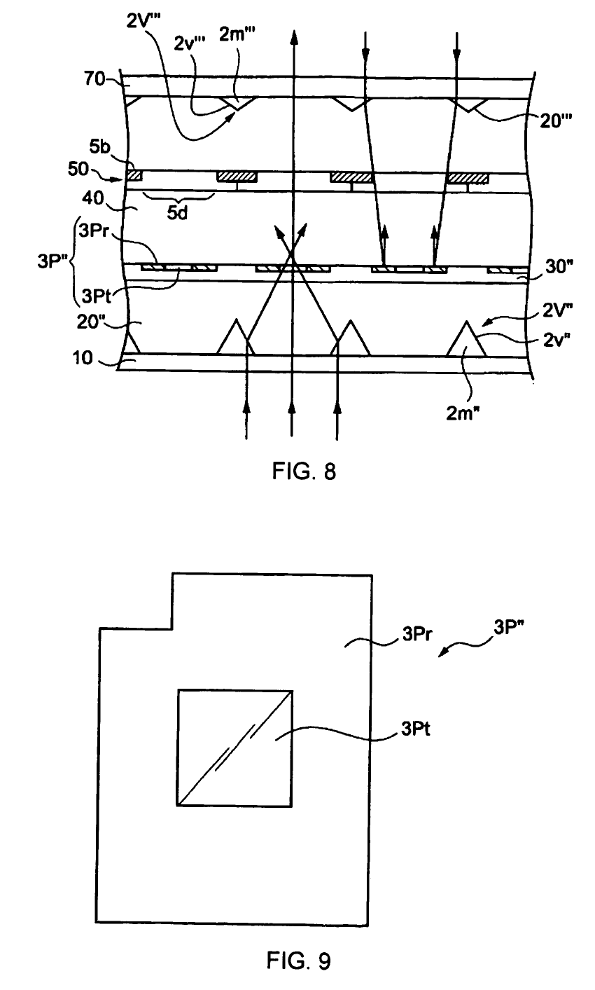

FIG. 8 shows an example of a transflective liquid crystal display device constructed using the optical collective substrate, and portions similar to those in FIG. 4 are assigned the same reference symbols as in FIG. 4.

In FIG. 8, two optical collective substrates are used. One optical collective substrate 20″ is used as a back substrate, while the other optical collective substrate 20″′ is used as a front substrate. A principal plane of the optical collective substrate 20″ on which the V-shaped groove is formed is faced to the back side of the apparatus, while a principal plane of the optical collective substrate 20″′ on which the V-shaped groove is formed is faced to the display surface side of the apparatus. In a TFT-composite layer 30″, there is formed a pixel electrode 3P″ comprised of a reflective electrode part 3Pr of a light reflective property and a transmissive electrode part 3Pt of a light transmissive property.

In this type of liquid crystal display device, external light incident from the front side is subjected to optical modulation corresponding to an image to be displayed and is reflected to lead to the front side, while incident light caused by the backlight from the back side is also subjected to optical modulation corresponding to an image to be displayed and is transmitted to lead to the front side. Then, efficiently displaying of images is achieved by mainly using the external light (ambient light) when the use environment is well-lighted (reflective mode), or by mainly using the light from the backlight when the use environment is dark (transmissive mode).

The pixel electrodes 3P″ are formed to adapt to this type. For example, the electrodes 3P″ can be formed in plane structure as shown in FIG. 9, and one pixel electrode 3P″ is comprised of the transmissive electrode part 3Pt located at the center and the reflective electrode part 3Pr around the part 3Pt. Accordingly, the pixel electrode 3P″ performs local application of voltage to an area of the liquid crystal layer 40, while the transmissive electrode part 3Pt causes the incident light from the backlight to be passed through to the liquid crystal layer 40 at the center portion of the pixel area, and the reflective electrode part 3Pr reflects the incident light from the front in an outer annular area surrounding the center portion (see FIG. 8).

Accordingly, the optical collective substrate 20″ on the back side has a role of collecting the light from the backlight to the transmissive electrode part 3Pt, while the optical collective substrate 20″′ on the front side has a role of collecting the light from the front side to the reflective electrode part 3Pr. Therefore, in this embodiment, the light-utilizable area defined in the optical collective substrate 20″ is an area of the transmissive electrode part 3Pt at the center, and the light-utilizable area defined in the optical collective substrate 20″′ is an area of the reflective electrode part 3Pr in the outer area.

It is noted that, also in this case, distances from the V-shaped groove portions 2V″ and 2V″′ to the light-utilizable areas, and the conditions to collect the light are respectively different from those in the case of FIG. 4. Therefore, the optical collective substrates 20″ and 20″′ are respectively formed to adapt to the conditions.

As is suggested from the foregoing, since the optical collective substrate 20″ needs to greatly increase the degree of narrowing the light, the inclined surfaces of the V-shaped groove 2v″ are made greatly abrupt, or the refractive index of the optically transmissive stuff 2m″ is set at a smaller value. The optical collective substrate 20″′ needs to collect the light to the reflective electrode part 3Pr occupying the outer area, and inclined surfaces of the V-shaped groove 2v ″′ and a refractive index of the optically transmissive stuff 2m″′ set accordingly.

Although this embodiment may also be modified in property and structure for other structural elements to adapt to the transflective liquid crystal display device, descriptions thereof are omitted herein for the sake of clarity.

In the above-mentioned embodiments, the groove formed on the optical collective substrate has a V-shaped outer outline symmetric with respect to a line on the sectional view. However, it may be modified in other various shapes.

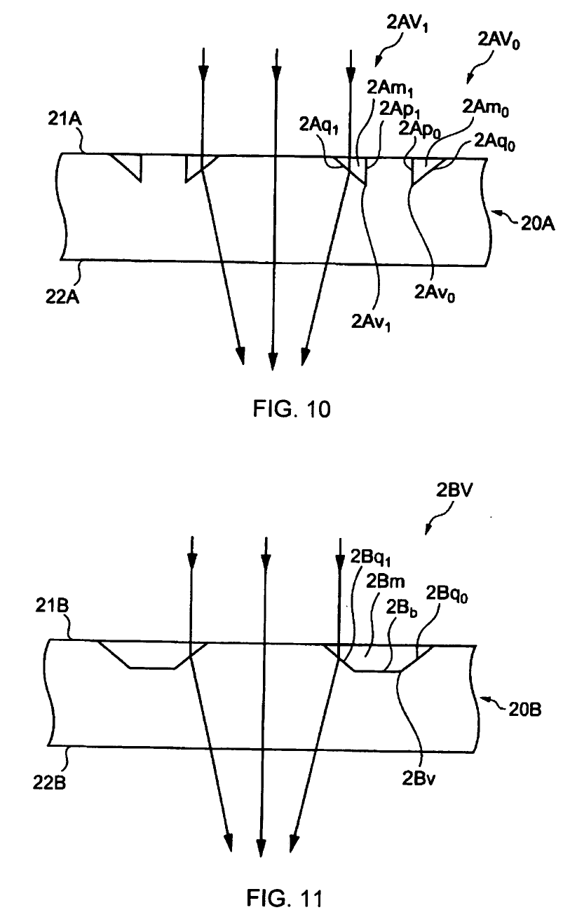

FIG. 10 shows one modification, where an optical collective substrate 20A uses a pair of modified V-shaped groove portions 2AV₀ and 2AV₁, instead of the V-shaped groove portions as described above. The modified V-shaped groove portions 2AV₀ and 2AV₁ comprise: modified V-shaped grooves 2Av₀ and 2Av₁ each consisting of a pair of an inclined plane 2Aq₀ or 2Aq₁ formed on one principal plane 21A of the optical collective substrate 20A in association with the light-utilizable area and a perpendicular plane 2Ap₀ or 2Ap₁ formed perpendicularly on the one principal plane 21A; and optically transmissive stuff 2Am₀ and 2Am₁ of a predetermined refractive index buried in the modified V-shaped grooves, respectively.

Also in such groove portions, the interface for mainly refracting the light is flat, so that the incident light from the one principal plane 21A side can be collected toward the light-utilizable areas without generation of chromatic aberration etc. Incidentally, the first inclined plane 2Aq₀ refracts the light toward one light-utilizable area, whereas the second inclined plane 2Aq₁ refracts the light toward another light-utilizable area adjacent to the one light-utilizable area.

In addition, it may be possible to make construction by combining the V-shaped groove as shown in FIG. 2 and the modified V-shaped groove as appropriate.

FIG. 11 shows another modification, where an optical collective substrate 20B uses a trapezoid groove portion 2BV, instead of the groove portions as described above. The trapezoid groove portion 2BV comprises: a trapezoidal groove 2Bv consisting of inclined planes 2Bq₀ and 2Bq₁ formed on one principal plane 21B of the optical collective substrate 20B in association with light-utilizable areas and a bottom surface 2Bb that is substantially parallel to the one principal plane and that extends between the inclined planes; and optically transmissive stuff 2Bm of a predetermined refractive index buried in the trapezoid groove.

Also in such a groove portion, the interface for mainly refracting the light is flat, so that the incident light from the one principal plane 21B side can be collected toward the light-utilizable areas without generation of chromatic aberration etc. Incidentally, the first inclined plane 2Bq₀ refracts the light toward one light-utilizable area, whereas the second inclined plane 2Bq₁ refracts the light toward another light-utilizable area adjacent to the one light-utilizable area.

In addition, it may be possible to make construction not only by combining the V-shaped groove as shown in FIG. 2 and the trapezoid groove as appropriate, but also by adding the form of the modified V-shaped groove as shown in FIG. 10 as appropriate.

Basically, it is possible to apply the manufacturing methods as described above to such modifications.

Although some embodiments are described above, the present invention is not limited to them but may be modified in other various forms. For instance, the optical collective substrates according to the present invention are not necessarily limited in application to liquid crystal display devices. They are basically applicable to any display devices that define an array of light-utilizable areas to which the light is collected as described above.

For the description, the embodiments are intended to have a color filter provided with a black matrix, but the present invention is not restricted to such an intention, and it is apparent to be able to apply the invention to a constitution in which another structural element is provided with a black matrix or the equivalent means, or to a constitution in which no black matrix exists.

As in the above, the preferable embodiments described herein are illustrative and not restrictive. The scope of the invention is indicated by the appended claims, and all variations that come within meanings of the claims are intended to be embraced in the present invention.

### LIST OF REFERENCE SYMBOLS

10 . . . polarizing plate
20, 20′, 20″, 20′″, 20A, 20B . . . optical collective substrate
21, 21A, 21B . . . one principal plane
22, 22A, 22B . . . the other principal plane
2v, 2v′, 2v″, 2v′″ . . . V-shaped groove
2Av₁, 2AV₀ . . . modified V-shaped groove
2Bv . . . trapezoid groove
2m, 2m′, 2m″, 2m′″, 2Am₀,2Am₁, 2Bm . . . optically transmissive stuff
2V, 2V′, 2V″, 2V′″ . . . V-shaped groove portion
2AV₀, 2AV₁ . . . . modified V-shaped groove portion
2BV . . . trapezoid groove portion
2AP₀, 2Ap₁, . . . perpendicular plane
2Aq₀, 2Aq₁, 2Bq₀, 2Bq₁ . . . inclined plane
2Bb . . . bottom surface
2p . . . flat surface
2v₀, 2v₁, . . . inclined surface
201 . . . light-utilizable area
202 . . . light-unutilizable area
30, 30′, 30″ . . . TFT-composite layer
31 . . . TFT
3S . . . source bus line
3G . . . gate bus line
3P, 3P′, 3P″ . . . pixel electrode
3Pr . . . reflective electrode part
3Pt . . . transmissive electode part
40 . . . liquid crystal layer
50 . . . color filter
5c . . . coloring layer
5b . . . black matrix (shield area)
5d . . . non-shield area
60 . . . transparent substrate
70 . . . polarizing plate

1. An optical collective substrate of an optically transmissive material having a structure in which incident light from one principal plane side of the substrate is locally collected in each place toward an array of light-utilizable areas formed on the outside of the other principal plane, wherein
the one principal plane is provided with a groove comprising an outline having at least one inclined plane associated with the light-utilizable area, the groove being filled with optically transmissive stuff of a predetermined refractive index, the filled groove portions making bases for allowing the incident light from the one principal plane side to be collected to the respective light-utilizable areas.

2. An optical collective substrate as defined in claim 1, characterized in that the groove extends along at least a part of an edge of the light-utilizable area.

3. An optical collective substrate as defined in claim 1, characterized in that the one principal plane has planes extending with a substantially equal height in areas other than the groove.

4. An optical collective substrate as defined in claim 1, characterized in that the optically transmissive stuff has a function of pasting an additional film to the one principal plane.

5. A display device using an optical collective substrate as defined in claim 1, comprising a display medium for forming images, which is disposed on the other principal plane side and carried on the optical collective substrate, the display device having pixels or predetermined displayed units corresponding to the light-utilizable areas.

6. A display device according to a display device in claim 5, characterized in that an additional film is pasted to the one principal plane by the optically transmissive stuff.

7. A display device according to claim 5, characterized in that the display medium is a liquid crystal medium.

8. A method of manufacturing an optical collective substrate of an optically transmissive material having a structure in which incident light from one principal plane side of the substrate is locally collected in each place toward an array of light-utilizable areas formed on the outside of the other principal plane, comprising:
a first step of forming, in the one principal plane, a groove comprising an outline having at least one inclined plane associated with the light-utilizable area; and
a second step of filling the groove with optically transmissive stuff of a predetermined refractive index.

9. A method as defined in claim 8, characterized in that the optically transmissive stuff has an adhesive property and the method further comprises a third step of affixing an additional film on the one principal plane using the adhesive property of the optically transmissive stuff.

10. A method as defined in claim 8, characterized in that the second step includes a process of applying the optically transmissive stuff to the one principal plane of the optical collective substrate.

11. A method as defined in claim 8, characterized in that the first step comprises a masking process of covering the one principal plane with a mask having a pattern that causes an area of a groove to be formed to be exposed and causes the other area to be masked and a spraying process of spraying the masked one principal plane of the optical collective substrate with a substance capable of etching the material of the optical collective substrate.

12. A method as defined in claim 11, characterized in that in the spraying process a spraying nozzle is used to blast the substance capable of etching, positioned opposed to the area of the groove, and moved along the extending pattern of the area of the groove while spraying the substance capable of etching in a condition that the nozzle is positioned at a center of the area of the groove in a direction traversing a moving direction of the nozzle.

13. A method of manufacturing a display device using an optical collective substrate of an optically transmissive material having a structure in which incident light from one principal plane side of the substrate is locally collected in each place toward an array of light-utilizable areas formed on the outside of the other principal plane, wherein:
the one principal plane is provided with a groove comprising an outline having at least one inclined plane associated with the light-utilizable area, the groove being filled with optically transmissive stuff of a predetermined refractive index, the filled groove portions making bases for allowing the incident light from the one principal plane side to be collected to the respective light-utilizable areas,
the method of manufacturing comprising:
a step of forming such a display mechanism construction including a display medium for forming an image on the other principal plane side of the optical collective substrate that the construction has pixels or predetermined displayed units corresponding to the light-utilizable areas.

14. A method according to claim 13, further comprising a step of pasting an additional film to the one principal plane of the optical collective substrate, wherein an adhesive property of the optically transmissive stuff makes adhesion of the additional film.
